(19) United States
(12) Patent Application Publication
(10) Pub. No.: US 2009/0303335 A1
(43) Pub. Date: Dec. 10, 2009

(54) Method of Spatial Frequency Filtering and Image Capture Device

(76) Inventor: Gerd Stueckler, Tegernsee (DE)

Correspondence Address: LATHROP & GAGE LLP, 4845 PEARL EAST CIRCLE, SUITE 201, BOULDER, CO, 80301, US

(21) Appl. No.: 12/302,246

(22) PCT Filed: May 22, 2007
(86) PCT No.: PCT/EP07/04533

§ 371 Date: Jun. 29, 2009

(30) Foreign Application Priority Data
May 24, 2006 (EP) 06010768.7

(51) Int. Cl. H04N 5/228

(52) U.S. Cl. 348/222.1; 348/E05.031

(57) ABSTRACT

The present invention relates to a method of spatial frequency filtering in an image capture device (3) having an objective lens (10) which projects an acquired image onto one or more opto-electronic image sensors (100; 200; 41, 42) having light-sensitive pixels (111, 112, 113, etc., 211, 212, 213, etc.), characterised in that, during the image capture, at least one opto-electronic image sensor (100; 200; 41, 42) and the image projected thereonto are moved relative to one another in the plane of the pixels, with the spatial vector of this relative movement covering predetermined points of occupancy over respective predetermined durations of occupancy.

### RELATED APPLICATIONS

This application is a national stage entry of PCT application serial number PCT/EP2007/004533, filed 22 May 2007, which claims benefit of priority to European patent application serial number 06010768.7, filed 24 May 2006. Each of the aforementioned applications are incorporated herein by reference.

### TECHNICAL FIELD

The invention relates to a method of spatial frequency filtering and to an image capture device.

In what follows, it will be essentially film cameras to which reference is made, but without the invention being limited to these. It is understood that the method according to the invention could equally well be applied to, for example, photo cameras or other image capture devices.

### BACKGROUND ART

To enable an image which is as true to nature and as free of artefacts as possible to be captured, cameras having digital opto-electronic image sensors having a regular pixel layout are fitted with facilities for optical pre-filtering, i.e. spatial frequency filtering. Optical pre-filtering is required in principle in digital image sensors when aliasing effects are to be avoided. It is not possible for so-called alias structures to be removed at a later stage by for example digital filtering of the data from the pixels because the digital data does not allow any distinction to be made between alias structures and structures making up the scene in the image.

The theoretical background is known in connection with the Nyquist-Shannon sampling theorem. The Nyquist frequency is given by half the sampling frequency.

The optical pre-filtering, i.e. the spatial frequency filtering, should therefore suppress as completely as possible all structures in the image of the scene to be captured that is projected onto the image sensor by the objective lens which are smaller or finer than the distance between two adjacent pixels of the same spectral light sensitivity and should, as far as possible, not suppress any structures which are larger than this. This is not possible in technical terms, so for this reason a compromise always has to be made between the suppression of alias artefacts and a sharpness of image which is as high as possible.

The light sensitivity of a theoretical ideal pixel of an image sensor should decrease with increasing distance from the centre of the pixel, although in this case the points on neighbouring pixels are covered as well. The corresponding direction-dependent curve depends both on the position-dependent curve followed by the light sensitivity of a real sensor pixel and on the geometrical layout of the sensor pixels relative to one another and also on the desired compromise between high image sharpness and high suppression of alias artefacts. An ideal optical pre-filter should distribute the light of the image onto an actual sensor pixel in such a way that the pixel has, as far as possible, the light-sensitivity curve of the pixel which is taken as ideal.

There are different ways of achieving this in the prior art. There are digital image capture devices in which the light-sensitivity curve of the sensor pixels relative to the image is changed solely by the blur or unsharpness of the objective lens. However, because the desired curve cannot under any circumstances be achieved in this way, what are used as a rule are optical filters specially designed for this purpose. Use is made in this way of scattering discs which are arranged in front of the sensor pixels and which widen the incident light rays in all directions so that a pixel records a larger region of the image. The dependence on direction which is required for the filtering cannot however be achieved in this way. Therefore, use is made above all of filters which are based on the principle of birefringence in crystals. An incident ray is split by the filter into for example two or four emergent rays, whereby direction-dependent filtering is achieved which in itself gives better results for normal pixel layouts. A method of this kind is disclosed in JP 10 229 525 A.

Disclosed in U.S. Pat. No. 5,915,047 A is an image pickup apparatus in which the occurrence of a Moiré pattern can be detected by varying the distance between the objective lens and an image sensor. The severity of the Moiré effect can then be reduced below a desired threshold level by moving the objective lens, i.e. by defocussing the image.

However, a desired position-dependent filter curve cannot be achieved by these methods.

One possible way of increasing the effectiveness of any optical pre-filtering is to use image sensors which give a resolution (result) which is higher than that desired. The filtering performance rises with the ratio between the fineness, i.e. frequency, of the pixel raster and the raster of the result. This solution however results in lower light sensitivity because in sensors which have a larger number of pixels the effective light-sensitive area per pixel goes down due to the incoming conductors which are needed on the sensor, because the size of the area per pixel which these latter need remains the same. What is more, this solution also results in an increased requirement for data processing and, hand in hand with this, in the need for more powerful electronics to be used whose energy consumption is greater.

Another disadvantage of known optical pre-filtering arrangements lies in the fact that the shape or characteristic of the filter curve is a fixed, preset one and cannot be varied. It would on the other hand be advantageous for the characteristic of the filtering to be able to be adapted to suit the situation. Portrait shots for example call for alias artefacts to be severely suppressed while the requirement for focus or sharpness is not great, whereas in medium-to-long shots in which there are many fine details and few regular structures, such as landscape shots, only a few alias artefacts generally occur and the main consideration is the greatest possible sharpness.

### DISCLOSURE OF THE INVENTION

The object which therefore exists is to provide improved optical pre-filtering, i.e. spatial frequency filtering.

In accordance with the invention, a method of spatial frequency filtering and an image capture device are presented having the features of this disclosure and the respective independent claims.

The explanatory details and advantages which are given below relate to all the solutions according to the invention unless they are explicitly described as not doing so. The image capture device according to the invention has appropriate means for carrying out the steps described.

A method of spatial frequency filtering, in an image capture device having an objective lens which projects an acquired image onto one or more digital opto-electronic image sensors having light-sensitive pixels, is proposed. During image capture, at least one opto-electronic image sensor and the image projected thereonto by the objective lens are moved relative to one another in the plane of the pixels, in particular in a controllable or regulatable manner. This can be accomplished in practice by moving the image sensor while the image remains fixed or by moving the image while the image sensor remains fixed or by a combination of the two movements. There are certain advantages to either option and these will be discussed in detail at a later stage. In the process mentioned, the movement vector of the relative movement covers predeterminable points of occupancy (occupied points), the duration of occupancy or speed at each of which can be predetermined. The movement vector thus defines a preferably closed trajectory or path of movement which can be used to characterise the movement.

Each pixel of the sensor moves relative to the image or the image moves relative to the sensor, as the case may be, which means that a sensor pixel senses a larger area of the image than would be the case if there were no relative movement. The points on the movement vector where the speed is lower, i.e. the duration of occupancy is longer, constitute points where the exposure time is increased and hence also where the relative light sensitivity of a sensor pixel is increased in relation to a corresponding point in the image.

By appropriate presetting of the points of occupancy, also referred to as occupied points, and of the speeds or in other words durations of occupancy of the position vector which are associated with these, in conjunction with the geometrical layout of the actual pixels and the position-dependent curve for their light sensitivity, any desired curve for the position-dependent light sensitivity of a sensor pixel relative to the image can be obtained.

A further particular advantage of the invention lies in the ability of the trajectory to be variably configured. It is possible in this way to achieve optical pre-filtering which, as described below, can be adapted to suit different shooting situations and different modes of operation of the camera.

Advantageous embodiments are disclosed in the dependent claims and in the following description.

The relative movement between sensor and image can be produced in a wide variety of ways, e.g. by means of electromagnetic driving members or ones which operate by the piezo effect. In this way an image sensor or an optical element can be moved at variable speeds along any desired trajectories at low manufacturing costs.

To simplify the description, it will always be the relative movement between the sensor and the image which is meant in what follows when a trajectory or movement of a sensor or pixel is mentioned. This relative movement may also be produced by means of movement of an optical element inserted in front of the sensor unless this is explicitly said not to be the case. A possibility which may be referred to here is for example that of using conventional image-stabilising arrangements with which digital cameras and film cameras are fitted. An image stabilising arrangement of this kind is shown for example in JP 2004 271 694 A. In such arrangements, optical elements, e.g. lenses, groups of lenses or prisms, which are inserted in front of the sensor, can be adjusted mechanically and in particular can be moved and/or pivoted laterally, so that shaking or pivoting movements on the part of the user of a camera can be compensated for. What this means is that a conventional image stabilising arrangement causes a section of the image acquired by a sensor to remain constant. By suitable re-programming, it is possible to cause a relative movement of the acquired image relative to the sensor by means of an arrangement of this kind.

The invention can be used in principle with all kinds of digital image sensors. Because the trajectories in pre-filtering according to the invention are necessarily always the same for all the pixels of a sensor, then when there are sensors having pixels of different spectral light sensitivities each type of pixel should preferably have the same static, position-related relative light sensitivity and the same geometrical position in the area of the sensor and hence there should also be the same number of each type of pixel.

As has already been explained above, a trajectory should be configured, amongst other things, as a function of the desired position-related light sensitivity curve of a pixel relative to the image, of the geometrical layout of the neighbouring pixels of the same spectral sensitivity, of the shapes of the pixels, and of any light-gathering lenses which there may be above the pixels. If for example the distance between a pixel and its neighbouring pixels of the same spectral sensitivity is greater in the horizontal direction than it is in the vertical direction, then the shape of the trajectories should allow for this asymmetry. The advantage of a trajectory which can be configured as desired is in particular that by taking its specific pixel layouts and parameters any desired optical filter curve can be obtained in the optimum way for any type of image sensor.

A vast range of different variants are conceivable for a trajectory. In this way, it will for example be enough in many cases simply to use a trajectory which is the result of superimposing simple circular movements or sinusoidal movements of different frequencies and amplitudes on one another in order to achieve an approximation of a desired position-related light sensitivity curve. A general form of a sinusoidal relative movement can in particular be represented as:

$$( \begin{matrix}x \\ y\end{matrix} ) = ( \begin{matrix}{\sum }_{j = 1}^{n} {a}_{j} sin ( {ϕ}_{j} + jω t ) \\ {\sum }_{k = 1}^{m} {b}_{k} sin ( {φ}_{k} + k ω t )\end{matrix} )$$

where ω=2πf and f=1/T where T is the image capture time.

From the relationship between the point occupied and the duration of occupancy on a trajectory of this kind produced by technical means and the physical and geometrical properties of a pixel, it is possible to derive a position-dependent relative light sensitivity profile for a pixel which is related to the image, thus enabling an assessment to be made of how good the approximation is by making a comparison with the desired light sensitivity profile.

It is useful for the movement of a sensor or optical element to be synchronised with the exposure time of the image capture so that the position-related curve for the relative light sensitivity of a pixel relative to the image which is obtained by means of the movement is not dependent on the exposure time. This is technically easy to accomplish in particular by a variation of speed. During an exposure or image capture the trajectory should therefore be traversed a whole (integer) number of times (i.e. once or more than once).

It is particularly useful if post-filtering matched to the pre-filtering is performed digitally. This is of advantage because each different position-related light sensitivity profile produces in a specific way, in the image signal from the sensor, desired and non-desired structures which will be captured. Only if the characteristic in the following downstream digital filtering is specifically matched by the image processing electronics to the optical pre-filter characteristic which is operative at the time, can an optimum resulting image be obtained. The characteristic required for the particular digital post-filtering can be calculated from the given position-related light sensitivity profile in the optical pre-filtering.

In another preferred embodiment, at least two non-identical intermediate images are captured and then processed to give a resulting image. The intermediate images are for example captured in succession by one image sensor which is displaced, preferably by one line of pixels, between the shots. Similarly, the intermediate images may be captured by at least two image sensors. Full-colour images may for example be captured, particularly with a Bayer sensor or a FOVEON X3 image sensor, or black and white images or partial colour images may be captured. Preferably, a black and white intermediate image will be captured or generated by one image sensor and a red/blue intermediate image by another image sensor. By the provision of at least two non-identical full colour, partial colour or black and white intermediate images, it is possible for the contrast and/or sharpness of the resulting image to be improved. The resulting image will advantageously have far more information (colour, luminance range, resolution, etc.) than will each intermediate image in itself.

In accordance with the invention, an image capture device is also presented. In advantageous embodiments, the image capture device according to the invention has means for performing embodiments of the method according to the invention.

In an advantageous embodiment, the image capture device has memory means for storing data on at least one trajectory or path of movement of the image sensor or optical element. The trajectories, and hence the position-related curve for the light sensitivity of a pixel relative to the image, are controllable, thus allowing different position-related light sensitivity profiles to be achieved, the parameters which are required for this purpose being able to be stored, particularly by the camera manufacturer, and being able to be called up again by the user. In one embodiment of the invention, three different trajectories for example can be called up. In the case of a trajectory intended for landscape shots, a pixel covers for example, in the movement, only a proportion of the quiescent region of neighbouring pixels of the same spectral sensitivity, thus producing high image sharpness with however only low suppression of alias artefacts. In the case of a further trajectory which is intended for normal shots, a pixel covers for example, in the movement, a high proportion of the quiescent regions of the closest neighbouring pixels. This trajectory provides a compromise between image sharpness and the suppression of alias artefacts which is suitable for the majority of image scenes. In the case of a third trajectory, a pixel covers for example, in the movement, all the quiescent regions of the closest and partly even of the more remote, neighbouring pixels. This trajectory makes possible a desired reduction in sharpness for portrait shots with excellent suppression of alias artefacts. Other, more finely graduated filter characteristics may be provided. It is also proposed that each stored trajectory be combined with an associated digital post-filtering function. Image capture devices having conventional optical filters have not so far had variable filtering of this kind.

In the case of cameras having two or more image sensors of the same type, further different trajectories or paths of movement may advantageously be executed and stored as required by the modes of operation. In this way, modes of operations may for example be provided for sensing an increased range of luminance or an increased image sharpness. In the latter case, the pixels of the sensors are for example offset relative to one another by a certain spacing in a certain direction in order to, in a known manner, produce a resulting image of greater sharpness from the different sets of data forming the images from the sensors. Trajectories will preferably be used in this case as if the camera had only a single sensor having a correspondingly larger number of pixels or pixel density, which will give trajectories of smaller amplitude and a different shape. Because the trajectories of the sensors are the same or identical herein, instead of the sensors a single optical element may also be moved to displace the image on the sensors.

In the case of cameras in which the image sensors are moved mechanically correspondingly to the intended trajectories, at least one of the mechanical arrangements is preferably used at the same time also to produce a displacement, which is constant during the exposure time, by a certain amount and in a certain direction of one image sensor relative to another sensor. This amount is preferably able to be stored and called up again, thus making it possible to switch as desired between two modes of operation in which there is and is not sensor displacement. What can preferably be stored and called up in addition is a displacement vector by means of which an unwanted mechanical offset resulting from manufacture between the pixels of two or more sensors can be corrected, which means that only an exactly parallel alignment of the rows or columns of pixels of the sensors has to take place in production.

Further advantages and embodiments of the invention can be seen from the description and the accompanying drawings.

The features which are mentioned above and which will also be explained below can be used not only in the combination which is specified in any given case but also in other combinations or on their own without exceeding the scope of the present invention.

A plurality of embodiments of the invention are shown in schematic form in the drawings and will be described in detail in what follows by reference to the drawings to describe the invention. In the drawings:

### BRIEF DESCRIPTION OF THE FIGURES

FIG. 1a shows a detail or cut-out of a first image sensor for use with an embodiment of the invention.

FIG. 1b shows an embodiment of a trajectory for the relative movement between sensor and image for the sensor shown in FIG. 1a.

FIG. 2a shows a detail of a second image sensor for use with an embodiment of the invention.

FIG. 2b shows an embodiment of a trajectory for the relative movement between sensor and image for the sensor shown in FIG. 2a.

FIG. 3 shows an embodiment of a camera having a rotating mirror wheel for distributing images to two image sensors.

### DETAILED DESCRIPTION OF THE FIGURES

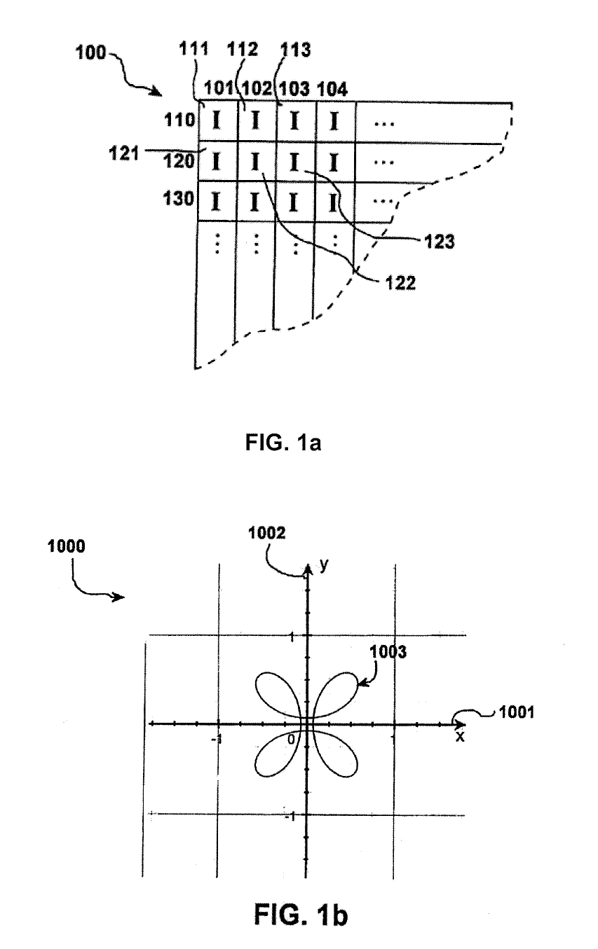

Shown in FIG. 1a in schematic form is a detail of a first image sensor 100. The image sensor 100 comprises pixels I of the same spectral sensitivity which are laid out in a square raster. The sensor 100 has sensor rows 110, 120, 130, etc. and sensor columns 101, 102, 103, 104, etc. Pixels 111, 112, 113, etc. of the same type are arranged next to one another in sensor row 110 and pixels 121, 122, 123, etc. of the same type are arranged next to one another in sensor row 120. Situated between the individual pixels there are for example provided incoming conductors and other electronic components which are not shown in the schematic view.

Sensors of this kind for use with an embodiment of the present invention are preferably fitted with pixels which are able to record all the colours of the visible spectrum at the same time or only an identical sub-range thereof.

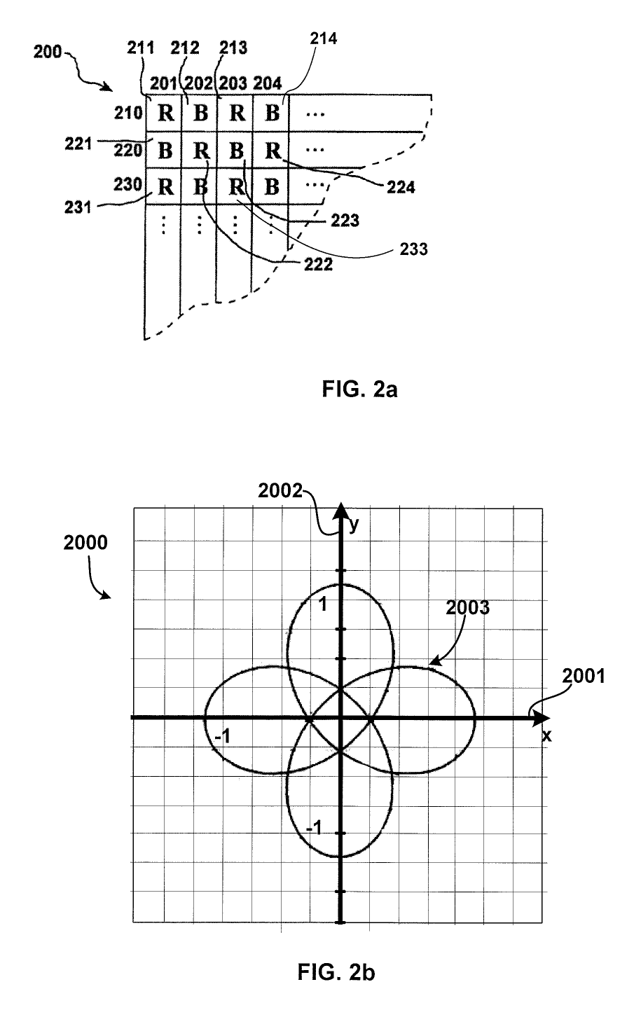

Shown schematically in FIG. 2a is a detail of a second image sensor 200. The image sensor 200 comprises pixels R and B of different spectral sensitivities which are laid out in a square raster. In the present case, the sensor 200 has for example red pixels R and blue pixels B which are laid out to alternate in sensor rows 210, 220, 230, etc. and sensor columns 201, 202, 203, 204, etc. In sensor row 210, red pixels 211, 213, etc. and blue pixels 212, 214, etc. are laid out next to one another to alternate, and in sensor row 220, blue pixels 221, 223, etc. and red pixels 222, 224, etc. are laid out next to one another to alternate.

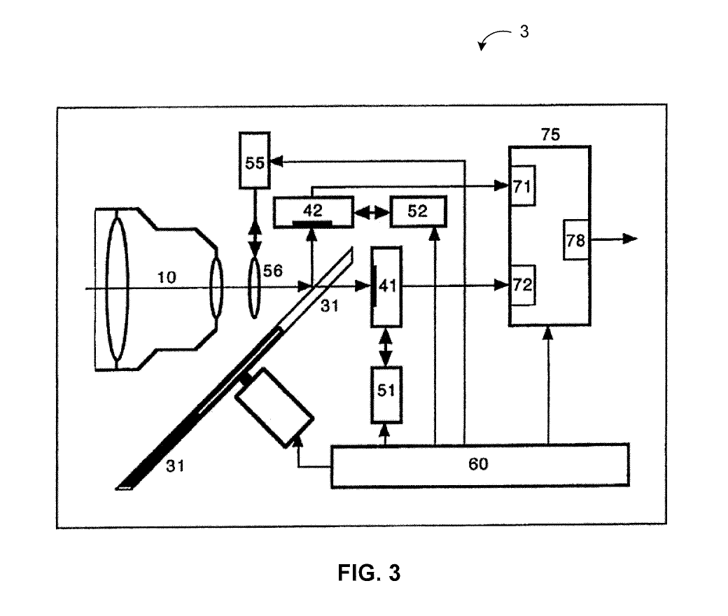

The second sensor 200 which has been described can be used, together with an image sensor 100 as shown in FIG. 1a having black and white, or green, pixels, in for example a two-sensor camera as shown in FIG. 3 in which a single resulting image 78 is determined in a known manner from the sets of image data 71, 72 from the two sensors 41, 42.

An example of a trajectory 1003 for a sensor as shown in FIG. 1a is shown in a graph 1000 in FIG. 1b. The graph 1000 has an x-axis 1001 and a y-axis 1002 which define a plane. This is the plane of the sensor. The origin of the co-ordinate system, i.e. the intersection of axes 1001 and 1002, is associated with the quiescent or home position represented by the centre of the sensor. Because all the individual pixels of an image sensor move with the centre of the sensor in an identical way thereto, the origin may likewise be associated with the centre of an individual pixel. The centres of adjacent individual pixels are spaced apart at their co-ordinates on the axes 1001 and 1002. Pixel 122 for example is situated at the origin (0/0) of the co-ordinate system, pixel 123 is situated at the location (1/0), pixel 112 at the location (0/1) and so on.

The trajectory 1003 is the result, in the present case, of the superposition of two circular movements defined by

X=0.42 cos(t)−0.35 cos(3t)

Y=0.42 sin(t)+0.35 sin(3t)

It should be noted that the numerical values used are merely preferred examples of parameters which can be represented in a general form as a, b, c, d. A more general formulation can be given in the respective cases in the forms x=a cos(t)−b cos(3t) and y=c sin(t)+d sin(3t).

The trajectory which is shown is of an approximately cross-like form, with the main axes of the cross being rotated through 45° from the co-ordinate axes. The four arms are of an approximately droplet-like form, with the shape approximately corresponding to a superposition of four circles whose centres are spaced at equal distances along the co-ordinate axes. It should be noted that the teaching according to the invention may for example also be implemented with a spiral trajectory or indeed with trajectories of any suitable form.

The direction in which the trajectory is traversed is immaterial. The coefficients are given here only as examples of pixel properties which are assumed in the present case and for a desired light sensitivity profile which is assumed in this case. Even better results can be achieved in the present case if for example even faster circular movements of smaller amplitude are superimposed on one another.

In this example, a sensor pixel senses an area of the image which is of considerably greater size when compared with its light sensitive area and thus also extends to quiescent points of the neighbouring pixels, with the resulting light sensitivity decreasing from the quiescent centre outwards and with it having the desired dependence on direction which is derived from the geometry of the pixel layout.

In a similar way to FIG. 1b, an example of a trajectory 2003 for a sensor as shown in FIG. 2a having two types of pixels of different colour sensitivities (R, B) is shown in a graph 2000 in FIG. 2b. The graph 2000 likewise has an x-axis 2001 and a y-axis 2002 which define a plane. The origin of the co-ordinate system is once again associated with the quiescent or home position represented by the centre of the sensor or a pixel. If R pixel 222 for example is situated at the origin (0/0) of the co-ordinate system, B pixel 223 is situated at location (1/0), but the closest R pixels are situated further away at locations 211, 213, 231 and 233.

Because the geometrical layout of the two types of pixels (R, B) is the same, the trajectory also results in identical light sensitivity profiles for each type of pixel. Because the nearest neighbouring pixels of the same colour sensitivity are situated further (about 1.4 times further) away from one another than in the case of the sensor shown in FIG. 1a and also lie in a different direction (at 45°), a different light sensitivity profile also has to be obtained. For this sensor, the corresponding trajectory is therefore of greater size and is orientated in a different direction. In the present case it is likewise the result of superimposing two circular movements, but ones with different coefficients:

X=0.48 cos(t)−0.68 cos(3t)

Y=0.48 sin(t)+0.68 sin(3t)

In this case too the numerical values are preferred values of parameters which can be represented in a general form as a, b, c, d.

The trajectory 2003 shown in FIG. 2b is similar to the trajectory 1003 shown in FIG. 1b but there are certain differences. In the case of the trajectory 2003, the arms of the cross are aligned parallel to the co-ordinate axes 2001, 2002. The form of the trajectory approximately corresponds to a superposition of four circles whose centres lie on diagonals of the co-ordinate system and whose radii are larger than the corresponding radii in FIG. 1b.

As in the case of FIG. 1, even better results can be achieved in the present case if for example even faster circular movements of smaller amplitude are superimposed on one another.

In other embodiments, it is also possible for trajectories of entirely different types to be used to achieve the desired light sensitivity profile. The superposition of two circular movements was selected here because it is particularly easy to technically implement and because it already makes possible a good approximation to the result that is desired in this case. However, the trajectories may equally well be defined by entirely different functions and that the embodiments which have been described here are to be seen merely as illustrations and not as limiting.

Shown in FIG. 3 is an embodiment of a digital camera which has an example of optical pre-filtering according to the invention and which is identified as a whole by reference numeral 3. In this digital camera, the image which is acquired by an objective lens 10 is projected onto two image sensors 41 and 42 by a rotating, sectored mirror wheel 31. The image sensor 41 takes the form of a black and white, or green, image sensor as shown in FIG. 1a and the image sensor 42 takes the form of a red/blue sensor as shown in FIG. 2a. In the embodiment of the invention which is being described, the image sensor 41 is moved along a trajectory as shown in FIG. 1b during exposure by a motor 51 and the image sensor 42 is moved along a trajectory as shown in FIG. 2b by a motor 52. The respective planes of movement are perpendicular to the plane of the drawing.

The sectored mirror wheel 31 rotates at high speed and is formed to have reflective and transmitting sectors, which means that during the exposure time the acquired image is projected, more than once if possible, alternately onto image sensors 41 and 42 respectively, whereby there is virtually simultaneous exposure of both sensors.

Provision is made for each image sensor always to receive the light from at least precisely one complete cycle of its individual trajectory during the exposure time of an image. However, in contrast to cameras which have a prism to distribute the image, the light flux onto a sensor during a cycle of this kind is interrupted or attenuated, once or more than once during the exposure time, by a sector of the sectored wheel. To ensure that the sensor pixels have a light sensitivity profile which is not affected by the sectored wheel, it is preferably always an even number of complete cycles of the path of movement or trajectories, with any desired starting point, which are executed during an exposure time of a pixel. In addition, the mirrored sectors and gap sectors are preferably of the same angular widths and the angle of rotation through which the sectored wheel moves is preferably always an odd-numbered multiple of the angle covered by a mirrored sector plus the angle covered by a gap sector. In cameras having two rotating, sectored mirror wheels to split the image up into three images, similar conditions apply.

If two identical sensors are used rather than the two sensors 100 and 200, then the trajectories required are identical too. When this is the case, rather than the sensors 41, 42 being moved by the two drives 52, 52, it is also possible for a single optical element 56 which is moved laterally by the drive 55 and which is positioned in front of the image distributor 31 to be used to produce the relative movement between image and sensor. It is of course also possible for an optical element having its own drive to be provided in front of each sensor. As in the case where there are separate sensor drives, this latter element would also allow for a desired static offset between the sensor pixels of the two sensors. As has already been described above, an offset of this kind can be used in a known manner to increase the sharpness of the resulting image 78. Because of the motor-controlled drives, this offset can be cancelled out again at any time in order for example, in a manner which is likewise known, to produce a resulting image which is able to show a large range of luminances.

Respective intermediate images 71 and 72 are captured by the image sensors 41 and 42. The intermediate images 71 and 72 are fed to an image processing device 75 which produces a resulting image 78 therefrom in a known way. The digital camera shown in FIG. 3 also has a camera controlling device 60 which is intended to control the image sensors 41 and 42, the motors 51, 52 and, where applicable, 55, the image processing device 75 and any further means or devices.

1. A method of spatial frequency filtering in an image capture device having an objective lens which projects an acquired image onto one or more opto-electronic image sensors provided with light-sensitive pixels, comprising:
moving at least of the one or more opto-electronic image sensors and an image projected thereon relative to one another in a plane of the image sensor's pixels,
controlling the relative movement utilizing a spatial vector of the relative movement, the spatial vector based on predetermined points of occupancy and a respective predetermined duration of occupancy for the predetermined points of occupancy.

2. The method according to claim 1, the step of moving comprising at least one of moving the image sensor in the plane of the image sensor's pixels and moving an optical element of the image capture device.

3. The method according to claim 1, wherein the relative movement between the image sensor and the image projected thereon is a superposition of sinusoidal movements.

4. The method according to claim 1, further comprising producing a position-dependent curve for light sensitivity of an image sensor pixel relative to the image by varying a point of occupancy and a respective predetermined duration of occupancy according to the spatial vector.

5. The method according to claim 1, the relative movement between the image sensor and the image projected thereon being synchronised with an exposure time of a capture of the image.

6. The method according to claim 1, further comprising matching digital post-filtering to the spatial frequency filtering.

7. The method according to claim 1, further comprising capturing at least two non-identical intermediate images by the at least one opto-electronic image sensor and processing the intermediate images to produce a resulting image.

8. An image capture device, comprising:
an objective lens which projects an acquired image onto at least one opto-electronic image sensor, the at least one image sensor having light-sensitive pixels;
means for producing a relative movement between the image sensor and an image projected thereonto according to a spatial vector;
the spatial vector based upon predetermined points of occupancy and a respective predetermined duration of occupancy for the predetermined points of occupancy.

9. The image capture device according to claim 8, further comprising a means for producing an additional displacement between the image sensor and the image projected thereon by a preset amount and in a preset direction, the additional displacement being constant at least during an exposure time of a capture of the image.

10. The image capture device according to claim 8, further comprising memory for storing data of at least one trajectory of an image sensor.

11. The method of claim 4, the spatial vector comprising at least one complete trajectory cycle during an image capture.

12. The method of claim 8, the means for producing the relative movement including means for moving the at least one opto-electronic image sensor in a plane of the pixels.

13. The method of claim 8, the means for producing the relative movement including means for moving an optical element of the image capture device.

14. The image capture device of claim 8, further comprising memory for storing data of a trajectory of an optical element of the image capture device.
